(19) United States
(12) Patent Application Publication
(10) Pub. No.: US 2026/0058599 A1
(43) Pub. Date: Feb. 26, 2026

(54) PIN LOCKING RAIL FOR SOLAR MODULE FRAME COUPLING

(71) Applicant: Nextracker LLC, Fremont, CA (US)

(72) Inventors: Ning Liu, Folsom, CA (US); Madeleine Davis Kho, Oakland, CA (US); Ricardo Delgado-Nanez, San Jose, CA (US)

(21) Appl. No.: 19/300,037

(22) Filed: Aug. 14, 2025

Related U.S. Application Data
(60) Provisional application No. 63/685,822, filed on Aug. 22, 2024.

(51) Int. Cl. H02S 30/10; F24S 25/634

(52) U.S. Cl. CPC H02S 30/10; F24S 25/634

(57) ABSTRACT

A sliding lock pin solar module frame coupling system includes a solar module and a pin locking rail. The solar module includes first and second spaced apart slots with different cross-sectional geometries. The pin locking rail includes a first channel, a second channel spaced apart from the first channel, a lock pin extending across the first channel and the second channel, and a sliding lock pin extending across the first channel and the second channel and spaced apart from the lock pin. When the lock pin is engaged with the first slot and the sliding lock pin is engaged with the second slot, the sliding lock pin is configured to be actuated to cause the sliding lock pin to move, relative to the second slot at the solar module frame and in a direction away from the lock pin, to a moved locking position at the second slot.

### RELATED APPLICATION

This disclosure claims priority to U.S. provisional patent application No. 63/685,822 filed on Aug. 22, 2024, the disclosure of which is hereby incorporated by reference.

### TECHNICAL FIELD

This disclosure relates generally to device, system, and method embodiments for coupling one or more solar module frames to a solar tracker. For example, such embodiments disclosed herein can couple one or more solar module frames to a torque tube of a solar tracker using a pin locking rail.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

A conventional solar tracking system includes a plurality of components assembled and installed on site in the field at the location where the solar tracking system is to be operated. Typical solar tracking system component installation utilizes manual labor on site in the field. For example, typical solar tracking system component installation utilizes manual labor to install rails at a torque tube for supporting one or more solar modules at the torque tube followed by additional manual labor to then install solar modules at the installed rails at the torque tube. This typically requires a high degree of tedious manual labor for many fastening connections to secure the rails at the torque tube and to then secure the solar modules at the installed rails. As such, the installation of solar modules at a torque tube for current solar tracking systems can add significant cost to a solar tracking system application.

### SUMMARY

This disclosure in general describes device, system, and method embodiments relating to solar module frames and solar module frame coupling apparatuses for coupling one or more solar module frames to a support structure of a solar tracker, such as a torque tube of a solar tracker. Such device, system, and method embodiments disclosed herein can be configured to facilitate more efficient and effective coupling installation of one or more solar module frames at a solar tracker support structure. For example, solar module frames and/or coupling apparatus embodiments disclosed herein can be configured to facilitate more efficient and effective installation of one or more solar module frames at a torque tube of a solar tracker (e.g., a single-axis solar tracker) to facilitate rotation of such one or more solar module frames with the torque tube. In some such examples, solar module frame coupling device, system, and method embodiments disclosed herein can be configured to facilitate automated (e.g., autonomous, such as fully or partially robotic) installation of one or more solar module frames to a torque tube using one or more solar module frame coupling apparatus embodiments disclosed herein. In additional or alternative such examples, solar module frame coupling device, system, and method embodiments disclosed herein can be configured to reduce a number of connection points needed between tracker components to effectively couple a solar module frame to a torque tube and, thereby, can help to reduce costs associated with solar tracker installation. For instance, some such embodiments disclosed herein can facilitate locking one or more solar module frames at a pin locking rail, which can be secured at a torque tube, by sliding such one or more solar module frames relative to the pin locking rail to thereby cause the one or more solar module frames to lock in place at the pin locking rail.

Pin locking rail embodiments disclosed herein can be configured to secure a pair of solar modules to a torque tube. A sliding lock pin solar module frame coupling system can include two solar modules and a pin locking rail. Each individual solar module can includes first and second spaced apart slots with different cross-sectional geometries. The pin locking rail can include a first channel, a second channel spaced apart from the first channel to accommodate module frame side by side, a fixed lock pin extending across the first channel and the second channel for front lock securement, and a sliding lock pin extending across the first channel and the second channel to lock/secure the modules at a rear portion. After the fixed lock pin is engaged with the first slot and the sliding lock pin is engaged with the second slot, the sliding lock pin can be configured to be actuated to cause the sliding lock pin to move, relative to the second slot at the solar module frame and in a direction away from the fixed lock pin, to a final locking position at the second slot at rear to thereby secure one or more solar modules at the torque tube via the pin locking rail.

One embodiment includes a method for coupling a solar module frame to a pin locking rail. This embodiment of the method includes the steps of: imparting relative movement between the solar module frame and the pin locking rail to cause a first slot at the solar module frame to engage a lock pin at the pin locking rail and to cause a second slot at the solar module frame to engage a sliding lock pin at the pin locking rail; when the first slot at the solar module frame is engaged to the lock pin at the pin locking rail and when the second slot at the solar module frame is engaged to the sliding lock pin at the pin locking rail, actuating the sliding lock pin to cause the sliding lock pin to move, relative to the second slot at the solar module frame and in a direction away from the lock pin, to a moved locking position; and locking the sliding lock pin at the moved locking position to couple solar module frame to the pin locking rail.

In a further embodiment of this method, the sliding lock pin can be actuated to cause the sliding lock pin to move relative to the second slot at the solar module frame and in a direction away from the lock pin while the lock pin remains stationary relative to the first slot at the solar module frame.

In a further embodiment of this method, actuating the sliding lock pin to cause the sliding lock pin to move, relative to the second slot at the solar module frame and in the direction away from the lock pin, to the moved locking position can include rotating an adjustable fastener at the sliding lock pin to cause the sliding lock pin to slide along and relative to the second slot at the solar module frame. As one such example, locking the sliding lock pin at the moved locking position can include moving a lock nut relative to the adjustable fastener at the sliding lock pin to cause the sliding lock pin to lock in place at the moved locking position at the second slot.

In a further embodiment of this method, imparting relative movement between the solar module frame and the pin locking rail can include sliding the solar module frame along the pin locking rail to cause the first slot at the solar module frame to receive the lock pin of the pin locking rail and to cause the second slot at the solar module frame to receive the sliding lock pin of the pin locking rail. As one such example, imparting relative movement between the solar module frame and the pin locking rail can include: (i) imparting first sliding movement of the solar module frame along the pin locking rail in a first direction to cause the first slot at the solar module frame to drop onto the lock pin of the pin locking rail and to cause the second slot at the solar module frame to drop onto the sliding lock pin of the pin locking rail, and (ii) after causing the first slot at the solar module frame to drop onto the lock pin of the pin locking rail and after causing the second slot at the solar module frame to drop onto the sliding lock pin of the pin locking rail, imparting second sliding movement of the solar module frame along the pin locking rail in the first direction to cause the lock pin to engage a longitudinal end of the first slot and to cause the sliding lock pin to engage a longitudinal end of the second slot. In one particular such example, locking the sliding lock pin at the moved locking position can include moving a lock nut in the first direction relative to an adjustable fastener at the sliding lock pin to cause the sliding lock pin to lock in place at the moved locking position at the second slot. For instance, this could include moving the lock nut along the adjustable fastener in the first direction until the lock nut contacts a sliding lock pin housing, with the sliding lock pin housing having at least a portion of the adjustable fastener and at least a portion of a sliding pin member of the sliding lock pin therein.

In a further embodiment of this method, the pin locking rail can include a first channel, a second channel, and an intermediate channel between the first and second channels. The solar module frame can be placed at the first channel at the pin locking rail prior to imparting relative movement between the solar module frame and the pin locking rail to cause the first slot at the solar module frame to engage the lock pin at the pin locking rail and to cause the second slot at the solar module frame to engage the sliding lock pin at the pin locking rail. The lock pin and the sliding lock pin can each extend across each of the first channel, the second channel, and the intermediate channel. For instance, actuating the sliding lock pin to cause the sliding lock pin to move, relative to the second slot at the solar module frame and in a direction away from the lock pin, to the moved locking position can include rotating an adjustable fastener of the sliding lock pin within the intermediate channel to cause the sliding lock pin to slide along and relative to the second slot of the solar module frame at the first channel.

Another embodiment includes a sliding lock pin solar module frame coupling system. This embodiment of the sliding lock pin solar module frame coupling system includes a solar module and a pin locking rail. The solar module includes first and second spaced apart slots with different cross-sectional geometries. The pin locking rail includes a first channel, a second channel spaced apart from the first channel, a lock pin extending across the first channel and the second channel, and a sliding lock pin extending across the first channel and the second channel and spaced apart from the lock pin. When the lock pin is engaged with the first slot and the sliding lock pin is engaged with the second slot, the sliding lock pin is configured to be actuated to cause the sliding lock pin to move, relative to the second slot at the solar module frame and in a direction away from the lock pin, to a moved locking position at the second slot.

In a further embodiment of this system, when the lock pin is engaged with the first slot and the sliding lock pin is engaged with the second slot, the sliding lock pin is configured to be actuated to cause the sliding lock pin to slide along at least each of the second slot at the solar module frame, the first channel, and the second channel in the direction away from the lock pin to the moved locking position. As a further such example, the pin locking rail can additionally include an intermediate channel between the first channel and the second channel, and the lock pin can extend across the first channel, the intermediate channel, and the second channel, and the sliding lock pin can extend across the first channel, the intermediate channel, and the second channel. In such as example, when the sliding lock pin is actuated to cause the sliding lock pin to move, relative to the second slot at the solar module frame and in the direction away from the lock pin, the lock pin can remain stationary relative to the first slot at the solar module frame. In some such examples, the slid lock pin can include a sliding pin member, and an adjustable fastener movably coupled to the sliding pin member, where the sliding lock pin is configured to be actuated to cause the sliding lock pin to slide along at least each of the second slot at the solar module frame, the first channel, and the second channel in the direction away from the lock pin to the moved locking position by rotating the adjustable fastener relative to the sliding pin member. In one further particular such example, the sliding lock pin can additionally include a lock nut that is configured to move relative to the adjustable fastener in the direction away from the lock pin to cause the sliding lock pin to lock in place at the moved locking position at the second slot. In one such instance, the sliding lock pin can further include a sliding lock pin housing that houses at least a portion of the adjustable fastener and at least a portion of a sliding pin member of the sliding lock pin therein. The lock nut can be configured to move relative to the adjustable fastener in the direction away from the lock pin to cause the locking nut to engage the sliding lock pin housing to thereby constrain movement of the adjustable fastener to thereby lock the sliding lock pin in place at the moved locking position at the second slot.

In a further embodiment of this system, the first slot defines a first cross-sectional geometry that comprises a vertical first slot inlet portion and a horizontal first slot portion extending from a first side of the vertical first slot inlet portion. And the second slot defines a second cross-sectional geometry that is different than the first cross-sectional geometry, with the second cross-sectional geometry comprising a vertical second slot inlet portion, a first horizontal second slot portion extending from a first side of the of the vertical second slot inlet portion, and a second horizontal second slot portion extending from a second, opposite side of the vertical second slot inlet portion. In some further such examples, the first slot can additionally include a first slot endwall that extends along a second side of the vertical first slot inlet portion opposite the first side of the vertical first slot inlet portion. In some such examples, the solar module has a first longitudinal side, and the first slot and the second slot are each defined at the first longitudinal side.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 illustrates a schematic, perspective view of a solar tracker apparatus.

FIGS. 2A and 2B illustrate an embodiment of a solar module frame coupled to an embodiment of a pin locking rail. FIG. 2A is a perspective view of the solar module frame coupled to a first pin locking rail at a first side of the solar module frame and coupled to a second pin locking rail at a second side of the solar module frame, and FIG. 2B is an elevational view of the solar module frame coupled to the first pin locking rail at a first side of the solar module frame and coupled to the second pin locking rail at a second side of the solar module frame of FIG. 2A.

FIG. 3 is a side elevational view of a portion of the solar module frame of FIGS. 2A and 2B showing exemplary first and second slots at the solar module frame.

FIGS. 4A-4D illustrate the pin locking rail embodiment of FIGS. 2A and 2B. FIG. 4A is a side perspective view of the pin locking rail, FIG. 4B is a top perspective view of the pin locking rail, FIG. 4C is a close-up perspective view of an embodiment of a sliding lock pin of the pin locking rail, and FIG. 4D is a perspective view of an embodiment of a sliding pin member of the sliding locking pin.

FIG. 5 is a flow diagram of an embodiment of a method for coupling a solar module frame to a pin locking rail.

FIGS. 6A-6F illustrate an exemplary sequence for coupling a solar module frame to a pin locking rail.

### DETAILED DESCRIPTION

The following detailed description is exemplary in nature. The following description provides some practical illustrations for implementing examples of the present invention. Those skilled in the art will recognize that many of the noted examples have a variety of suitable alternatives.

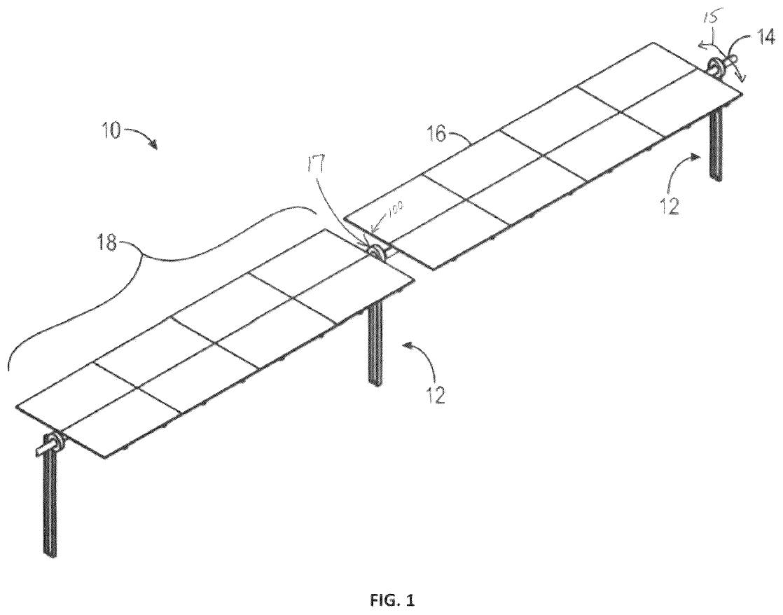

FIG. 1 illustrates an embodiment of a solar tracker apparatus 10. The solar tracker apparatus 10 can include a plurality of piers 12 disposed in spaced relation to one another and embedded in the ground. The solar tracker apparatus 10 can include one or more torque tubes 14 that can extend between adjacent piers 12 and can be rotatably supported at each pier 12. The solar tracker apparatus 10 can further include a plurality of solar modules 16 (e.g., solar panels having photovoltaic cells, such as a photovoltaic laminate with a plurality of photovoltaic cells, at a frame) supported at the torque tube 14. The one or more torque tubes 14 can be rotated in directions 15 so as to change an angle of the solar modules 16 (e.g., throughout a day as the location of the sun changes relative to the solar modules 16). A bearing housing assembly 17 can be configured to rotatably connect torque tubes 14 along a span of the solar tracker apparatus 10. The span between two adjacent piers 12 can be referred to as a bay 18 and, for example, in certain applications may be generally in the range of about 8 meters in length and each bay 18 can be rotatably connected to an adjacent bay 18 via the bearing housing assembly 17. A plurality of solar tracker apparatus 10 rows may be arranged in a north-south longitudinal orientation to form a solar array.

Each solar module 16 can include a solar module frame 100 that is coupled to the torque tube 14. As will be described herein, in some instances, the solar module frame 100 can be directly coupled to the torque tube 14 and in other instances the solar module frame 100 can be indirectly coupled to the torque tube 14 by coupling the solar module frame 100 directly to a rail component and coupling that rail to the torque tube 14. As will also be described herein, in various embodiments, adjacent pairs solar module frames 100 of adjacent pairs of solar modules 16 can be coupled together to the torque tube 14 (e.g., indirectly using a common rail component).

The following disclosure will describe various solar module frame coupling apparatus embodiments that can be used, for instance, at a solar tracker to couple one or more (e.g., a pair of) solar modules to a torque tube of a solar tracker. Such embodiments disclosed herein can be useful in facilitating more labor-efficient solar module frame installation at a solar tracker apparatus by helping to reduce the number of active component connections needed during installation. For instance, embodiments disclosed herein can reduce a number of connection points, such as between a solar module frame and a rail, between a solar module frame and a torque tube, and/or between a rail and a torque tube. These embodiments can thus be useful in increasing the cost efficiency associated with installing a solar tracker system in the field as the time and labor needed can be reduced. For example, such embodiments disclosed herein can provide structures at solar module frame components and/or rail components that are conducive to robotic installation along a robotic work axis while also reducing a number of connection points.

Thus, solar module frame coupling apparatuses, and the components thereof, can be configured to facilitate more efficient and effective coupling installation of one or more solar module frames to a support structure, such as a rail at a torque tube. Namely, in such an example, solar module frame coupling apparatus embodiments disclosed herein can be configured to facilitate more efficient and effective installation of one or more solar module frames to a torque tube, such as in solar tracker applications, for instance, such as that shown at the example of FIG. 1. These solar module frame coupling apparatus embodiments will be discussed as follows in conjunction with the accompanying drawing figures.

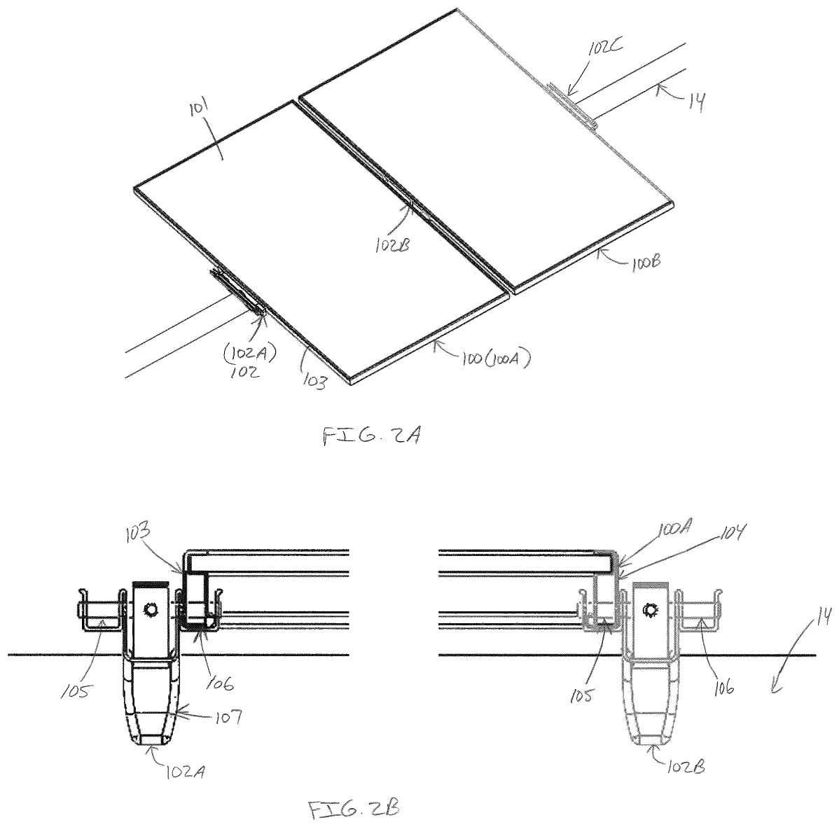

FIGS. 2A and 2B illustrate an embodiment of a solar module frame 100 coupled to an embodiment of a pin locking rail 102. The solar module frame 100, as noted previously, can support a plurality of photovoltaic cells 101 at the solar module frame 100.

FIG. 2A is a perspective view of the solar module frame 100 coupled to a first pin locking rail 102A at a first side of the solar module frame 100 and coupled to a second pin locking rail 102B at a second side of the solar module frame 100. As illustrated here, a given pin locking rail 102 (e.g., 102B) can be configured to receive and couple to a pair of solar module frames 100A, 100B to thereby couple such pair of solar module frames 100A, 100B to the torque tube 14. For instance, first pin locking rail 102A can be configured to receive and couple to a longitudinal side 103 of solar module frame 100A at one side of first pin locking rail 102A and to another solar module frame at an opposite side of first pin locking rail 102A, second pin locking rail 102B can be configured to receive and couple to solar module frame 100A at one side of second pin locking rail 102B and to solar module frame 100B at an opposite side of second pin locking rail 102B, and third pin locking rail 102C can be configured to couple to solar module frame 100B at one side of third pin locking rail 102C and to another solar module frame at an opposite side of third pin locking rail 102C. Thus, a sliding lock pin solar module frame coupling system can include at least one solar module frame 100 and at least one pin locking rail 102.

FIG. 2B is an elevational view of the solar module frame 100A coupled to each of the first pin locking rail 102A at a first longitudinal side 103 of the solar module frame 100A and coupled to the second pin locking rail 102B at a second longitudinal side 104 of the solar module frame 100A. Each pin locking rail 102 can be configured to interface with the torque tube 14. For instance, each pin locking rail 102 can include a base 107 that is configured to interface with (e.g., contact, such as sit on) torque tube 14. As will be described and illustrated further, the pin locking rails 102A, 102B can each include a first channel 105 and a second channel 106. The first pin locking rail 102A can be configured to receive, and lock to, one solar module frame at the first channel 105 and be configured to receive, and lock to, another solar module frame 100A at the second channel 106. Likewise, the second pin locking rail 102B can be configured to receive, and lock to, one solar module frame 100A at the first channel 105 and be configured to receive, and lock to, another solar module frame at the second channel 106. As such, the pin locking rail 102 can be placed at the torque tube 14 (e.g., coupled to the torque tube 14, such as via a mating connection or using a strap) and solar module frames 100 can be coupled to the pin locking rails 102 to couple the solar module frames 100 to the torque tube 14 to rotate therewith.

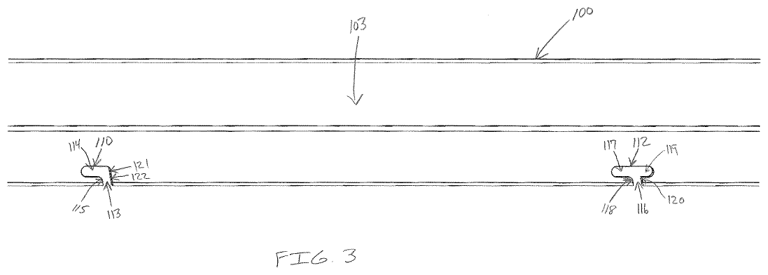

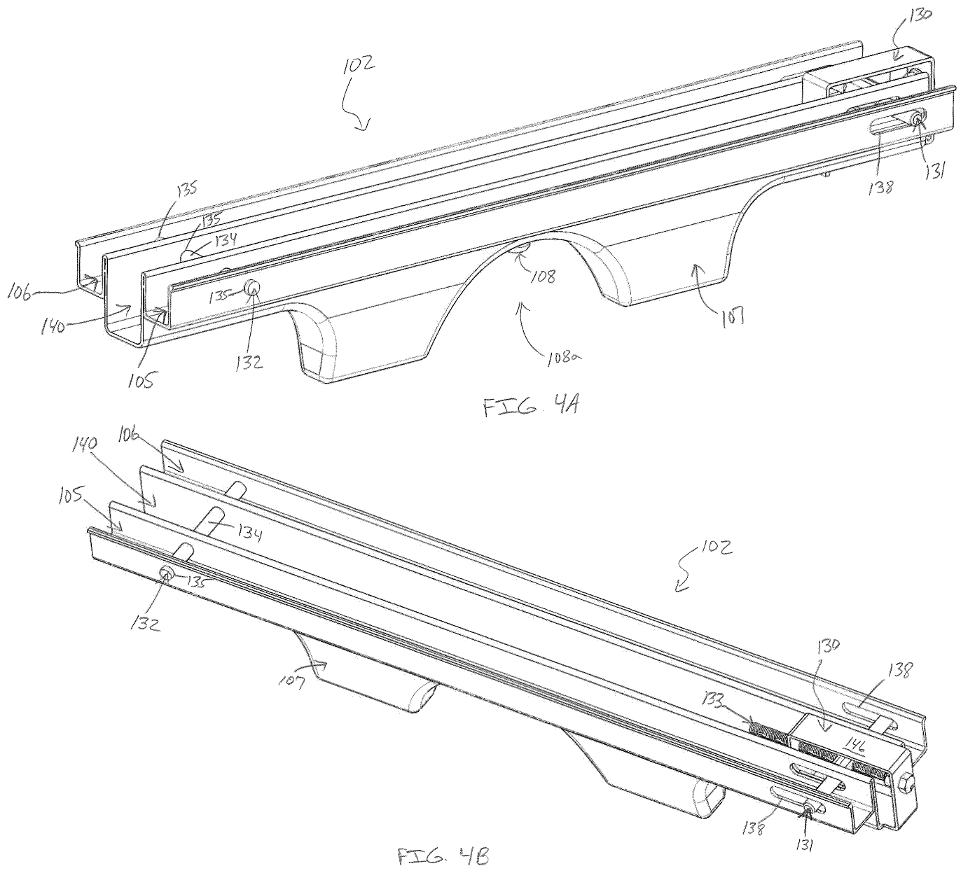

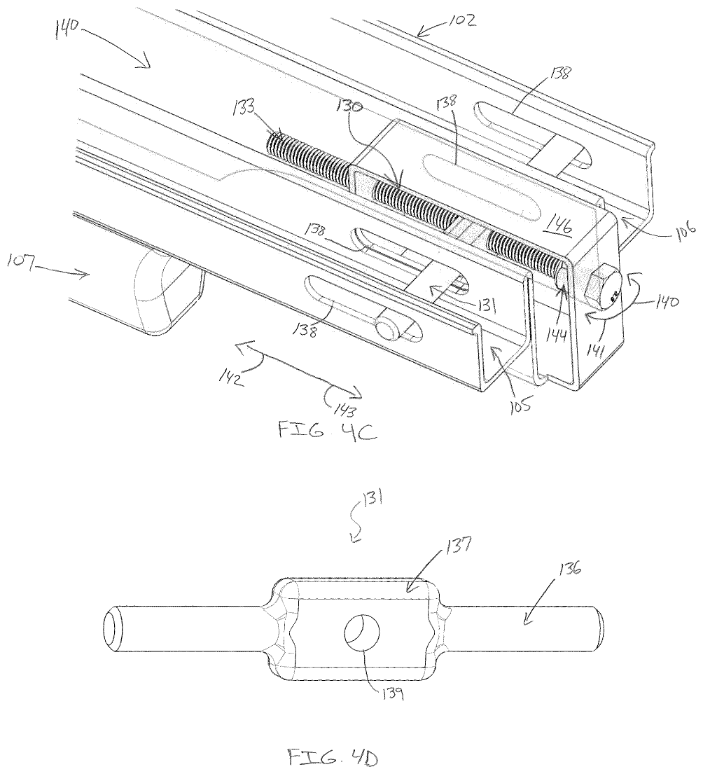

As will be described here in reference to FIGS. 3 and 4A-4D, the solar module frames 100 and/or the pin locking rails 102 can include one or more features to facilitate coupling solar module frames 100 to the torque tube 14 using one or more pin locking rails 102. Such solar module frame coupling to the one or more pin locking rails 102 can act to couple the solar module frame to the torque tube in a more efficient manner that can help to reduce a number of intercomponent connections needed and thereby act to decrease the cost associated with installing a solar tracker apparatus.

FIG. 3 is a side elevational view of a portion of the solar module frame 100 showing an exemplary first slot 110 and second slot 112 at the solar module frame 100. The inclusion of the first and second slots 110, 112 at the solar module frame can help to configure the solar module frame for coupling (e.g., locking) to a pin locking rail.

The first slot 110 can be spaced apart from the second slot 112 along a side 103 of the solar module frame 100. The first and second slots 110, 112 can be spaced apart from one another along the side 103 of the solar module frame 100 a distance that generally corresponds to a distance between a lock pin and a sliding lock pin at the pin locking rail. For applications where the solar module frame 100 is a rectangular solar module frame as illustrated here, the side 103 can be a longitudinal side of the solar module frame 100 that is longer than a radial side of the solar module frame 100.

The first slot 110 can define a different cross-sectional geometry than the second slot 112. For instance, the second slot 112 can define a cross-sectional geometry that is different than the first slot 110 cross-sectional geometry and that results in the second slot 112 having a larger cross-sectional area than the cross-sectional area of the different geometry first slot 110. Such different cross-sectional geometry of the first and second slots 110, 112 can help to facilitate actuation of a sliding lock pin at the pin locking rail to cause the sliding lock pin to move relative to the second slot 112 while a lock pin at the first slot 110 can remain stationary relative to the first slot 110, as will be described further herein.

As shown for the exemplary embodiment here at FIG. 3, the first slot 110 can define a first cross-sectional geometry that comprises a vertical first slot inlet portion 113 and a horizontal first slot portion 114 extending from a first side 115 of the vertical first slot inlet portion 113. In addition, the first cross-sectional geometry defined by the first slot 110 can include a first slot endwall 121 extending along a second side 122 of the vertical first slot inlet portion 113 opposite the first side 115 of the vertical first slot inlet portion 113. As also shown for the exemplary embodiment here, the second slot 112 can define a second cross-sectional geometry that is different than the first cross-sectional geometry. Namely, the second cross-sectional geometry defined by the second slot 112 can include a vertical second slot inlet portion 116, a first horizontal second slot portion 117 extending from a first side 118 of the of the vertical second slot inlet portion 116, and a second horizontal second slot portion 119 extending from a second, opposite side 120 of the vertical second slot inlet portion 116. Thus, for the illustrated embodiment, the first and second slots 110, 112 can both define cross-sectional areas that have the same or similar vertical first slot inlet portions 113, 116 and the same or similar horizontal first slot portions 114, 117, but the first and second slots 110, 112 can differ in cross-sectional geometry and area as a result of the first slot 110 cross-sectional geometry including the first slot endwall 121 while the second slot instead includes the second horizontal second slot portion 119 to increase the cross-sectional area at the second slot 112 as compared to that at the first slot 110.

FIGS. 4A-4D illustrate detailed views of the pin locking rail 102. FIG. 4A is a side perspective view of the pin locking rail 102, FIG. 4B is a top perspective view of the pin locking rail 102, FIG. 4C is a close-up perspective view of an embodiment of a sliding lock pin 130 of the pin locking rail 102, and FIG. 4D is a perspective view of an embodiment of a sliding pin member 131 of the sliding locking pin 130.

The pin locking rail 102 can be configured to interface with, and couple to, a torque tube of a solar tracker apparatus to thereby couple one or more (e.g., a pair) of solar module frames 100 to the torque tube. To do so, the pin locking rail 102 can include a torque tube coupling member 108 and a torque tube coupling cutout 108a. The torque tube coupling member 108 can be configured to engage the torque tube (e.g., as shown for the example here the torque tube coupling member 108 is a dimple that is configured to sit in a complementary dimple aperture at the torque tube), and the torque tube coupling cutout 108a can correspond to a cross-sectional geometry of the torque tube (e.g., as shown for the example here the torque tube coupling cutout 108a is semi-circular to correspond to a circular cross-sectional torque tube geometry).

The pin locking rail 102 can include the first channel 105 and the second channel 106 defined at a body of the pin locking rail 102. The pin locking rail 102 can additionally include a lock pin 132 and the sliding lock pin 130, and the lock pin 132 and the sliding lock pin 130 can each extend across the first channel 105 and the second channel 106 with the sliding lock pin 130 spaced apart along the body of the pin locking rail 102 from the lock pin 132. The illustrated embodiment further illustrates that the pin locking rail 102 can include an intermediate channel 140 that is located between the first channel 105 and the second channel 106. As shown for this illustrated embodiment, the lock pin 132 and the sliding lock pin 130 can each extend across each of the first channel 105, the intermediate channel 140, and the second channel 106. In this way, when a first solar module frame 100 is to be coupled and locked to the pin locking rail 102, a side of the first solar module frame 100 can be placed at the first channel 105 and engaged to each of the lock pin 132, such as the first slot 110, and the sliding lock pin 130, such as at the second slot 112. Similarly, when a second solar module frame 100 is to be coupled and locked to the pin locking rail 102, a side of the second solar module frame 100 can be placed at the second channel 106 and engaged to each of the lock pin 132, such as the first slot 110, and the sliding lock pin 130, such as at the second slot 112. In this way, the lock pin 132 and the sliding lock pin 130 can each engage a pair of solar module frames by engaging one solar module frame at each of the lock pin 132 and the sliding lock pin 130 at the first channel 105 and engaging another solar module frame at each of the lock pin 132 and the sliding lock pin 130 at the second channel 106. The intermediate channel 140 can be included, for instance, to accommodate one or more portions of the sliding lock pin 130, such as to accommodate at the intermediate channel 140 an adjustable fastener 133 of the sliding lock pin 130 as shown at the example at FIG. 4B.

The lock pin 132 can include a lock pin shaft 134. The lock pin shaft 134 can be configured to sit at pin apertures 135 included at walls that define the first channel 106, the intermediate channel 140, and the second channel 106. Thus, to extend across the first channel 105, the intermediate channel 140, and the second channel 106, the lock pin shaft 134 can have a length at least as long as the distance between pin aperture 135 at an outside wall of the first channel 105 and pin aperture 135 at an outside wall of the second channel 106. The lock pin shaft 134 can define a cross-sectional geometry that is configured to be received within the vertical first slot inlet portion 113 and sit at the horizontal first slot portion 114 at the first slot 110 at the frame 100.

Referring to FIGS. 4C and 4D, the sliding lock pin 130 can include the sliding pin member 131 and the adjustable fastener 133. The adjustable fastener 133 can be movably coupled to the sliding pin member 131. For example, as shown for the illustrated embodiment, the sliding pin member 131 can include a sliding pin shaft 136 and a central body 137.

The sliding pin shaft 136 can extend out from opposite sides of the central body 137, and the sliding pin shaft 136 can be configured to sit at sliding pin apertures 138 included at walls that define the first channel 106, the intermediate channel 140, and the second channel 106. The sliding pin apertures 138 can be larger (e.g., elongated in the longitudinal direction parallel to the central longitudinal axis of the rail body) than the pin apertures 135 to facilitate sliding movement of the sliding pin shaft 136 of the sliding pin member 131 relative to (e.g., along) the sliding pin apertures 138. To extend across the first channel 105, the intermediate channel 140, and the second channel 106, the sliding pin shaft 136 can have a length at least as long as the distance between sliding pin aperture 138 at an outside wall of the first channel 105 and sliding pin aperture 138 at an outside wall of the second channel 106. The sliding pin shaft 136 can define a cross-sectional geometry that is configured to be received within the vertical first slot inlet portion 116 and sit at the first horizontal second slot portion 117 and the second horizontal second slot portion 119 at the second slot 112 at the frame 100.

The central body 137 can include a shaft receiving aperture 139 that receives the adjustable fastener 133. The central body 137 can define a height that is greater than a height of the sliding pin shaft 136 such that the central body 137 can extend above and/or below the sliding pin shaft 136 as shown at the example at FIG. 4D. The example at FIG. 4D illustrates the central body 137 as a generally rectangular cross-sectional shape, though other embodiments can include different cross-sectional shapes for the central body 137, such as circular, oval, or other geometry. The central body 137 can be configured to interface with the walls defining the intermediate channel 140 such that the central body 137 can sit within the intermediate channel 140 along with the adjustable fastener 133 while the sliding pin shaft 136 extends out from the intermediate channel 140 to extend across each of the first and second channels 105, 106.

The adjustable fastener 133 can be movably engaged at the shaft receiving aperture 139 such that the adjustable fastener 133 can move through the shaft receiving aperture 139. For instance, the illustrated embodiment shows that the adjustable fastener 133 can include a threaded shaft and the shaft receiving aperture 139 can include threading complementary to the threaded shaft of the adjustable fastener 133 such that the complementary threading at the threaded shaft and the shaft receiving aperture 139 can facilitate movement of the sliding pin member 131 along the adjustable fastener 133.

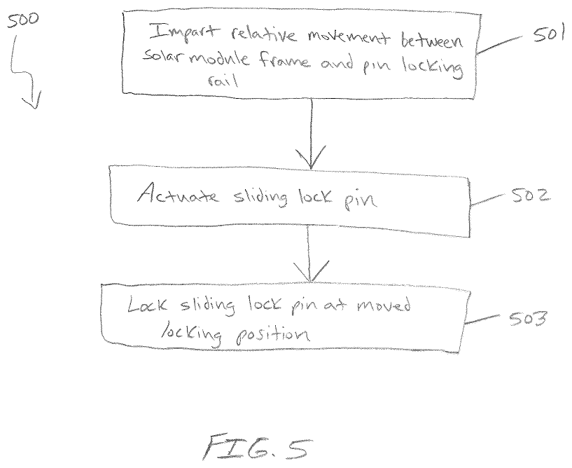

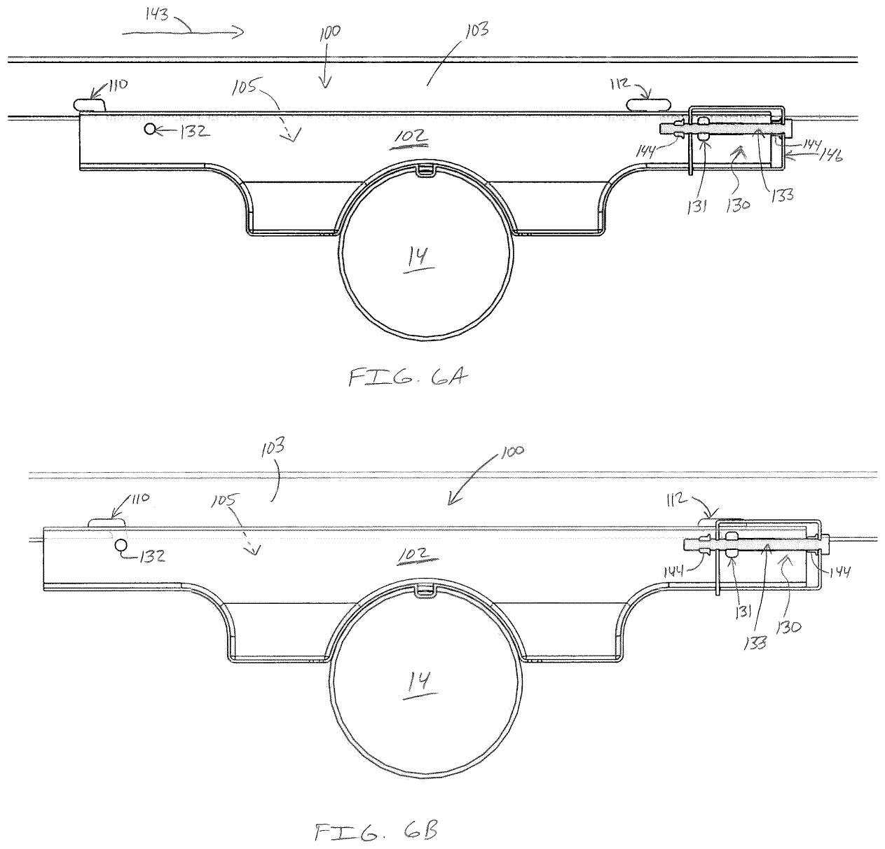

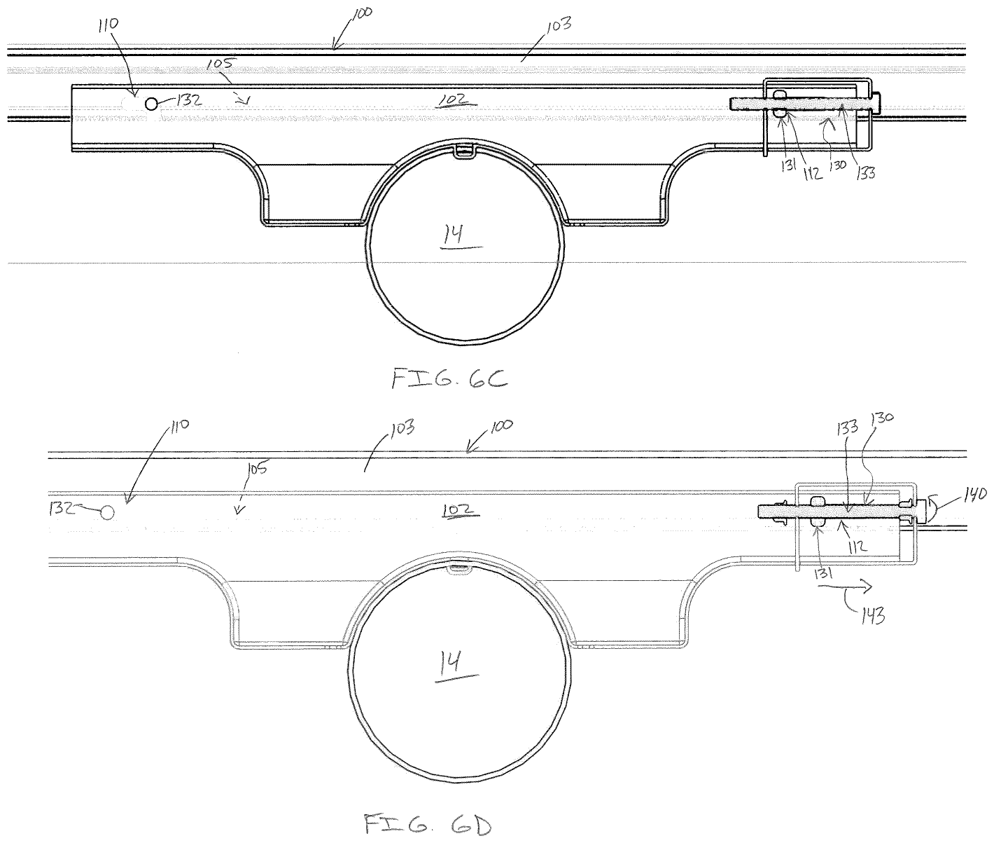

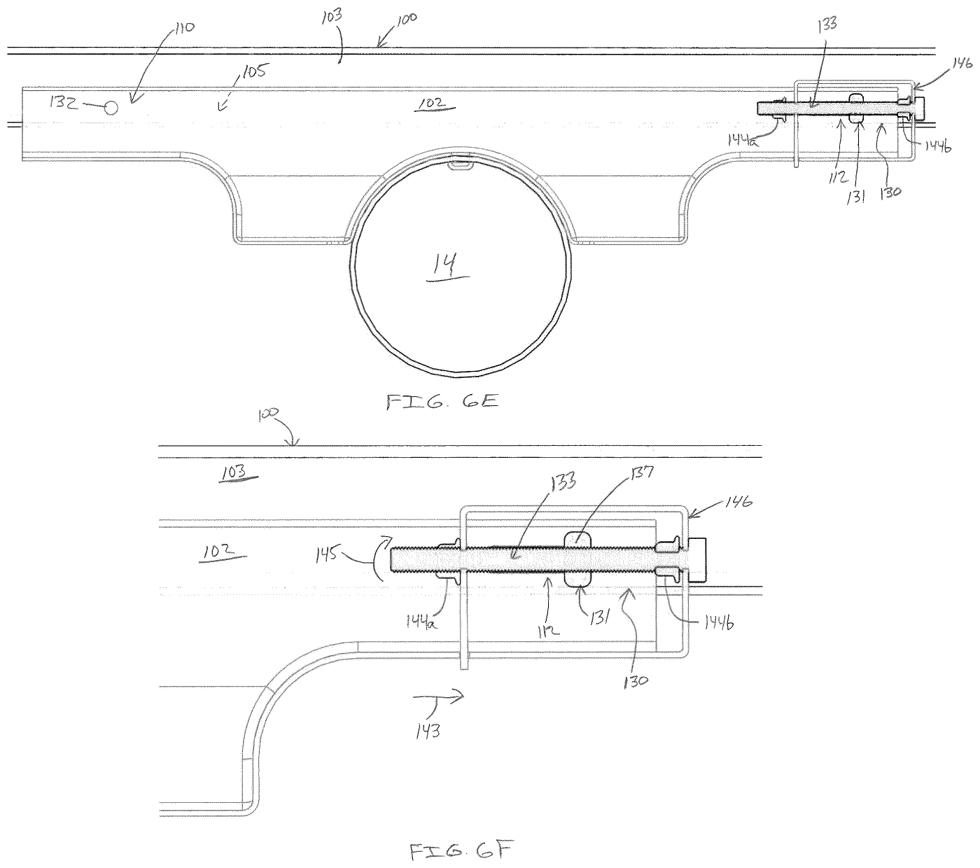

Thus, the adjustable fastener 133 can be movably coupled to the sliding pin member 131 such that actuation of the adjustable fastener 133 can cause the sliding pin member 131 to move along the adjustable fastener 133 and relative to the sliding pin apertures 138. For example, for the illustrated embodiment, the adjustable fastener 133 can be actuated by rotating the adjustable fastener 133 in a directions 140, 141 to cause the sliding pin member 131 to move along the adjustable fastener 133 in directions 142, 143. Namely, the adjustable fastener 133 can be actuated by rotating the adjustable fastener 133 in the direction 140 to cause the sliding pin member 131 to move along the adjustable fastener 133 in the direction 143. Similarly, for one additional example, the adjustable fastener 133 can be actuated by rotating the adjustable fastener 133 in the direction 141 to cause the sliding pin member 131 to move along the adjustable fastener 133 in the direction 142. As the sliding pin member 131 is caused to move along the adjustable fastener 133 via actuation of the adjustable fastener 133, the sliding pin member 131 can likewise be caused to move along the sliding pin apertures 138 (and along the second slot 112 at one, or at a pair of, solar modules when engaged at the rail 102). Accordingly, as will be detailed further in reference to FIGS. 5 and 6A-6F, the sliding lock pin 130 can be configured to be actuated to cause the sliding lock pin 130 (e.g., the sliding pin member 131) to slide along at least each of the second slot 112 at the solar module frame 100 (when engaged at the rail 102, such as shown at FIGS. 2A and 2B), the first channel 105, the intermediate channel 140, and the second channel 106 in the direction 143 away from the lock pin 132 to a moved locking position of the sliding lock pin 130 (e.g., a moved locking position of the sliding pin member 131) by rotating the adjustable fastener 133 (e.g., in the direction 140) relative to the sliding pin member 131.

The illustrated embodiment of the sliding lock pin 130 can further include one or more lock nuts 144. Each of the one or more lock nuts 144 can be configured to lock the sliding lock pin 130 in place at and relative to the rail 102. For instance, prior to and during actuation of the adjustable fastener 133 to cause the sliding pin member 131 to move (e.g., slide), the one or more lock nuts 144 can be at an unlocked lock nut position that allows for movement/actuation of the adjustable fastener 133 and thus of the sliding pin member 131. Once the sliding lock pin 130 has been moved to the moved locking position (at the second slot 112 of the frame 100), one or more lock nuts 144 can be actuated (e.g., torqued) to move relative to the adjustable fastener 133 (e.g., move along the adjustable fastener 133) in the direction 143 away from the lock pin 132 to cause the sliding lock pin 130 to lock in place at the moved locking position at the second slot 112.

Additionally, the illustrated embodiment of the sliding lock pin 130 can further include a sliding lock pin housing 146. For instance, at seen at FIGS. 4B and 4C, the sliding lock pin housing 146 can house at least a portion of the adjustable fastener 133 and at least a portion of a sliding pin member 131 of the sliding lock pin 130 therein. For instance, the sliding lock pin housing 146 can provide a mounting support structure for the adjustable fastener 133. The one or more lock nuts 144 can be configured to move relative to the adjustable fastener 133 in the direction 143 away from the lock pin 132 to cause the one or more locking nuts 144 to engage the sliding lock pin housing 146 to thereby constrain movement of the adjustable fastener 133 when the one or more lock nuts 144 are engaged at the sliding lock pin housing 146 to thereby lock the sliding lock pin 130 in place, such as to lock the sliding pin member 131 and the adjustable fastener 133 in place, at the moved locking position at the second slot 112 of the frame 100.

As will be described further and is illustrated in reference to FIGS. 5 and 6A-6F, when the lock pin 132 is engaged with the first slot 110 of a given frame 100 (or a pair of frames 100) and the sliding lock pin 130 is engaged with the second slot 112 of the given frame 100 (or a pair of frames 100), the sliding lock pin 130 can be configured to be actuated to cause the sliding lock pin 130 to move, relative to the second slot 112 at the frame 100 (or pair of frames 100) and in the direction 143 away from the lock pin 132, to a moved locking position (e.g., as shown at FIGS. 6E and 6F) at the second slot 112 of the frame (or pair of frames 100). In particular, for some such embodiments, when the lock pin 132 is engaged with the first slot 110 of the frame 100 (or pair of frames) and the sliding lock pin 130 is engaged with the second slot 112 of the frame 100 (or pair of frames), the sliding lock pin 130 can be configured to be actuated (e.g., by rotating the adjustable fastener 133) to cause the sliding lock pin 130 to slide along at least each of the second slot 112 at the solar module frame 100 (or pair of frames), the first channel 105, and the second channel 106 in the direction 143 away from the lock pin 132 to the moved locking position. And, when the sliding lock pin 130 is actuated to cause the sliding lock pin 130 to move, relative to the second slot 112 at the solar module frame 100 (or pair of frames) and in the direction 143 away from the lock pin 132, the lock pin 132 can remain stationary relative to the first slot 110 at the solar module frame 100 (or pair of frames).

FIG. 5 is a flow diagram of an embodiment of a method 500 for coupling solar module frame 100 to pin locking rail 102. The method 500 can be executed in various examples manually by hand, in an automated manner using an installation automation device, such as movable robotic installation device, or in part manually by hand and in other part using an installation automation device. The method 500 can be executed using any one or more of the features described and illustrated previously herein with respect to the solar module frame(s) 100 and the pin locking rail 102.

The embodiment of the method 500 will be described as follows in reference to the flow diagram at FIG. 5 and also in reference to the exemplary installation sequence shown at FIGS. 6A-6F. FIGS. 6A-6F illustrate an exemplary sequence for coupling a solar module frame to a pin locking rail (e.g., FIGS. 6A-6F can be in chronological order in the sequence such that FIG. 6A starts the relative sequence and FIG. 6F ends the relative sequence). Reference to the exemplary installation sequence shown at FIGS. 6A-6F is intended to be illustrative of examples of executing the method 500, and other examples of the method 500 can include other features or steps, and/or omit certain features or steps, in the installation sequence.

The pin locking rail 102 can, in some examples, be pre-configured with the lock pin 132 and the sliding lock pin 130 prior to installing the pin locking rail 102 at the torque tube. Thus, prior to installing the pin locking rail 102 at the torque tube, the pin locking rail 102 can include the lock pin 132 extending across each of the first channel 105, the intermediate channel 140, and the second channel 106 at the rail 102 and include the sliding lock pin 130 extending across each of the first channel 105, the intermediate channel 140, and the second channel 106 at the rail 102. In some applications of the method 500, the method 500 can include a step prior to the step 501 of placing (e.g., coupling) a slide locking rail 102 at a torque tube 14 where the slide locking rail 102 placed at the torque tube 14 includes the lock pin 132, extending across each of the first channel 105, the intermediate channel 140, and the second channel 106 at the rail 102, and includes the sliding lock pin 130, extending across each of the first channel 105, the intermediate channel 140, and the second channel 106 at the rail 102 prior to executing step 501.

At step 501, the method 500 includes imparting relative movement between a solar module frame and a pin locking rail to cause a first slot at the solar module frame to engage a lock pin at the pin locking rail and to cause a second slot at the solar module frame to engage a sliding lock pin at the pin locking rail. As one example, the solar module frame can be placed at the first channel at the pin locking rail prior to imparting relative movement between the solar module frame and the pin locking rail to cause the first slot at the solar module frame to engage the lock pin at the pin locking rail and to cause the second slot at the solar module frame to engage the sliding lock pin at the pin locking rail. As noted, the lock pin and the sliding lock pin each extend across each of the first channel, the second channel, and the intermediate channel. At step 501, for example, imparting relative movement between the solar module frame and the pin locking rail can including sliding the solar module frame along the pin locking rail to cause the first slot at the solar module frame to receive the lock pin of the pin locking rail and to cause the second slot at the solar module frame to receive the sliding lock pin of the pin locking rail. As one specific such example, imparting relative movement between the solar module frame and the pin locking rail can include: (i) imparting first sliding movement of the solar module frame along the pin locking rail in a first direction to cause the first slot at the solar module frame to drop onto the lock pin of the pin locking rail and to cause the second slot at the solar module frame to drop onto the sliding lock pin of the pin locking rail, and (ii) after causing the first slot at the solar module frame to drop onto the lock pin of the pin locking rail and after causing the second slot at the solar module frame to drop onto the sliding lock pin of the pin locking rail, imparting second sliding movement of the solar module frame along the pin locking rail in the first direction to cause the lock pin to engage a longitudinal end of the first slot and to cause the sliding lock pin to engage a longitudinal end of the second slot.

For instance, FIGS. 6A-6D illustrate one exemplary portion of a sequence for coupling solar module frame 100 to pin locking rail 102 by imparting relative movement between the solar module frame 100 and the pin locking rail 102 to cause the first slot 110 at the solar module frame 100 to engage the lock pin 132 at the pin locking rail and to cause the second slot at the solar module frame to engage the sliding lock pin at the pin locking rail (e.g., step 501). As illustrated at FIG. 6A, the side 103 of the solar module frame 100 can be placed at the first channel 105 at the pin locking rail 102 prior to imparting relative movement between the solar module frame 100 and the pin locking rail 102 to cause the first slot 100 at the solar module frame 100 to engage the lock pin 132 at the pin locking rail 102 and to cause the second slot 112 at the solar module frame 100 to engage the sliding lock pin 130 at the pin locking rail 102. Then, at step 501, for example, imparting relative movement between the solar module frame 100 and the pin locking rail 102 can including sliding the solar module frame 100 along the pin locking rail 102 in the direction 143 shown at FIG. 6A to, as shown at FIGS. 6B-6D, cause the first slot 110 at the solar module frame 100 to receive the lock pin 132 and to cause the second slot 112 at the solar module frame 100 to receive the sliding lock pin 130 (e.g., to receive the sliding pin member 131 at the second slot 112).

As one specific such example seen at the portion of the sequence at exemplary FIGS. 6B-6D, imparting relative movement between the solar module frame 100 and the pin locking rail 102 can include: (i) imparting first sliding movement of the solar module frame 100 (e.g., including imparting first sliding movement of the side 103 of the frame 100) along the pin locking rail 102 in direction 143 to cause the first slot 110 at the solar module frame 100 to drop onto the lock pin 132 of the pin locking rail 102 (e.g., as seen at the sequence of FIGS. 6A-6C) and to cause the second slot 112 at the solar module frame 100 to drop onto the sliding lock pin 130 of the pin locking rail 102 (e.g., as seen at the sequence of FIGS. 6A-6C), and (ii) after causing the first slot 110 at the solar module frame 100 to drop onto the lock pin 132 of the pin locking rail 102 and after causing the second slot 112 at the solar module frame 100 to drop onto the sliding lock pin 130 of the pin locking rail 102, imparting second, subsequent sliding movement of the solar module frame 100 along the pin locking rail 102 in the direction 143 to cause the lock pin 132 to engage a longitudinal end of the first slot 110 and to cause the sliding lock pin to engage a longitudinal end of the second slot 112. For example, as shown at the sequence at FIGS. 6C-6D, after causing the first slot 110 at the solar module frame 100 to drop onto the lock pin 132 of the pin locking rail 102 and after causing the second slot 112 at the solar module frame 100 to drop onto the sliding lock pin 130 of the pin locking rail 102, imparting second, subsequent sliding movement of the solar module frame 100 along the pin locking rail 102 in the direction 143 can cause the lock pin 132 to engage a longitudinal end of the first slot 110 by causing the lock pin 132 to engage the horizontal first slot portion 114 of the first slot 110 extending from the first side 115 of the vertical first slot inlet portion 113 of the first sot 110 and can cause the sliding lock pin 130 to engage a longitudinal end of the second slot 112 by causing the sliding lock pin 130 to engage the first horizontal second slot portion 117 of the second slot 112 extending from the first side 118 of the of the vertical second slot inlet portion 116. For instance, after executing the step 501, the solar module frame 100 and pin locking rail 102 can be positioned relative to one another as shown at FIG. 6D—e.g., with the lock pin 132 positioned at the horizontal first slot portion 114 of the first slot 110 and with the sliding lock pin 130 positioned at the first horizontal second slot portion 117 of the second slot 112.

At step 502, when the first slot 110 at the solar module frame 100 is engaged to the lock pin 132 at the pin locking rail 102 and when the second slot 112 at the solar module frame 100 is engaged to the sliding lock pin 130 at the pin locking rail 102, for instance as a result of having executing step 501, and such as shown at FIG. 6D, the method 500 includes actuating the sliding lock pin 130 to cause the sliding lock pin 130 to move, relative to the second slot 112 at the solar module frame 100 and in direction 143 away from the lock pin 132, to a moved locking position, such as shown at FIGS. 6E and 6F. For example, such as shown at the sequence of FIGS. 6E-6F, the moved locking position of the sliding lock pin 130 can have the sliding pin member 131 positioned at the second horizontal second slot portion 119 that extends from the second, opposite side 120 of the vertical second slot inlet portion 116. Thus, as shown at the sequence of FIGS. 6E-6F, step 502 can include moving (e.g., sliding) the sliding pin member 131 from the first horizontal second slot portion 117 of the second slot 112 (e.g., where the sliding pin member 131 was positioned as a result of step 501) to the second horizontal second slot portion 119 of the second slot 112.

According to the illustrated embodiment, the sliding lock pin 130 can be actuated to cause the sliding lock pin 130 (e.g., the sliding pin member 131) to move relative to the second slot 112 at the solar module frame 100 and in direction 143 away from the lock pin 132 while the lock pin 132 remains stationary relative to the first slot 110 at the solar module frame 100. As one such example, actuating the sliding lock pin 130 to cause the sliding lock pin 130 (e.g., the sliding pin member 131) to move, relative to the second slot 112 at the solar module frame 100 and in the direction 143 away from the lock pin 132, to the moved locking position by rotating the adjustable fastener 133 at the sliding lock pin 130 to cause the sliding lock pin 130 (e.g., the sliding pin member 131) to slide along and relative to the second slot 112 at the solar module frame 100. For instance, as shown at the sequence of FIGS. 6D-6E, rotating the adjustable fastener 133 in the rotational direction 140 can cause the sliding pin member 131 to slide along and relative to the second slot 112 in the direction 143 (e.g., in a direction away from the torquer tube 14 and away from the lock pin 132). As also shown for the illustrated embodiment, actuating the sliding lock pin 130 to cause the sliding lock pin 130 to move, relative to the second slot 112 and in the direction 143 away from the lock pin 132, to the moved locking position can include causing the adjustable fastener 133 to rotate within the intermediate channel 140 to cause the sliding lock pin 130 (e.g., the sliding pin member 131) to slide along and relative to the second slot 112 of the solar module frame 100 at the first channel 105, such as shown at the sequence of FIGS. 6D-6E.

At step 503, the method 500 incudes locking the sliding lock pin 130 at the moved locking position to couple solar module frame 100 to the pin locking rail 102. For example, according to the illustrated embodiment shown at the sequence of FIGS. 6E-6F, locking the sliding lock pin 130 at the moved locking position (e.g., locking the sliding lock pin 130 at the moved locking position of the sliding pin member 131 at the second horizontal second slot portion 119 of the second slot 112) can include moving lock nut 144a relative to the adjustable fastener 133 at the sliding lock pin 130 to cause the sliding lock pin 130 to lock in place at the moved locking position at the second slot 112. As shown at the exemplary sequence of FIGS. 6E-6F, locking the sliding lock pin 130 at the moved locking position at the second slot 112 can include moving the lock nut 144a in the direction 143, relative to (e.g., along) the adjustable fastener 133 at the sliding lock pin 130 to cause the sliding lock pin 130 to lock in place at the moved locking position at the second slot 112. For example, the lock nut 144a can be moved along the adjustable fastener 133 in the direction 143 until the lock nut 144a contacts the sliding lock pin housing 146, which sliding lock pin housing 146 can have at least a portion of the adjustable fastener 133 therein and at least a portion of a sliding pin member 131 therein. In some applications of the method 500, such as shown at the sequence at FIGS. 6E-6F, the lock nut 144a can be moved along the adjustable fastener 133 in the direction 143 until the lock nut 144a contacts the sliding lock pin housing 146 by rotating the lock nut 144a, in direction 145 and relative to the adjustable fastener 133, to cause the lock nut 144a to move along the adjustable fastener 133 in the direction 143 until the lock nut 144a contacts the sliding lock pin housing 146.

Various examples have been described. These and other examples are within the scope of this disclosure and claims pursed from this disclosure.

What is claimed is:

1. A method comprising the steps of:
imparting relative movement between a solar module frame and a pin locking rail to cause a first slot at the solar module frame to engage a lock pin at the pin locking rail and to cause a second slot at the solar module frame to engage a sliding lock pin at the pin locking rail;
when the first slot at the solar module frame is engaged to the lock pin at the pin locking rail and when the second slot at the solar module frame is engaged to the sliding lock pin at the pin locking rail, actuating the sliding lock pin to cause the sliding lock pin to move, relative to the second slot at the solar module frame and in a direction away from the lock pin, to a moved locking position; and
locking the sliding lock pin at the moved locking position to couple solar module frame to the pin locking rail.

2. The method of claim 1, wherein the sliding lock pin is actuated to cause the sliding lock pin to move relative to the second slot at the solar module frame and in a direction away from the lock pin while the lock pin remains stationary relative to the first slot at the solar module frame.

3. The method of claim 2, wherein actuating the sliding lock pin to cause the sliding lock pin to move, relative to the second slot at the solar module frame and in the direction away from the lock pin, to the moved locking position comprises rotating an adjustable fastener at the sliding lock pin to cause the sliding lock pin to slide along and relative to the second slot at the solar module frame.

4. The method of claim 3, wherein locking the sliding lock pin at the moved locking position comprises moving a lock nut relative to the adjustable fastener at the sliding lock pin to cause the sliding lock pin to lock in place at the moved locking position at the second slot.

5. The method of claim 1, wherein imparting relative movement between the solar module frame and the pin locking rail comprises sliding the solar module frame along the pin locking rail to cause the first slot at the solar module frame to receive the lock pin of the pin locking rail and to cause the second slot at the solar module frame to receive the sliding lock pin of the pin locking rail.

6. The method of claim 5, wherein imparting relative movement between the solar module frame and the pin locking rail comprises:
(i) imparting first sliding movement of the solar module frame along the pin locking rail in a first direction to cause the first slot at the solar module frame to drop onto the lock pin of the pin locking rail and to cause the second slot at the solar module frame to drop onto the sliding lock pin of the pin locking rail, and
(ii) after causing the first slot at the solar module frame to drop onto the lock pin of the pin locking rail and after causing the second slot at the solar module frame to drop onto the sliding lock pin of the pin locking rail, imparting second sliding movement of the solar module frame along the pin locking rail in the first direction to cause the lock pin to engage a longitudinal end of the first slot and to cause the sliding lock pin to engage a longitudinal end of the second slot.

7. The method of claim 6, wherein locking the sliding lock pin at the moved locking position comprises moving a lock nut in the first direction relative to an adjustable fastener at the sliding lock pin to cause the sliding lock pin to lock in place at the moved locking position at the second slot.

8. The method of claim 7, wherein the lock nut is moved along the adjustable fastener in the first direction until the lock nut contacts a sliding lock pin housing, the sliding lock pin housing having at least a portion of the adjustable fastener and at least a portion of a sliding pin member of the sliding lock pin therein.

9. The method of claim 1,
wherein the pin locking rail comprises a first channel, a second channel, and an intermediate channel between the first and second channels,
wherein the solar module frame is placed at the first channel at the pin locking rail prior to imparting relative movement between the solar module frame and the pin locking rail to cause the first slot at the solar module frame to engage the lock pin at the pin locking rail and to cause the second slot at the solar module frame to engage the sliding lock pin at the pin locking rail, and
wherein the lock pin and the sliding lock pin each extend across each of the first channel, the second channel, and the intermediate channel.

10. The method of claim 9, wherein actuating the sliding lock pin to cause the sliding lock pin to move, relative to the second slot at the solar module frame and in a direction away from the lock pin, to the moved locking position comprises rotating an adjustable fastener of the sliding lock pin within the intermediate channel to cause the sliding lock pin to slide along and relative to the second slot of the solar module frame at the first channel.

11. A sliding lock pin solar module frame coupling system comprising:
a solar module comprising a first slot and a second slot spaced apart from the first slot, the first slot defining a different cross-sectional geometry than the second slot; and
a pin locking rail comprising:
a first channel,
a second channel spaced apart from the first channel,
a lock pin extending across the first channel and the second channel, and
a sliding lock pin extending across the first channel and the second channel and spaced apart along the pin locking rail from the lock pin,
wherein, when the lock pin is engaged with the first slot and the sliding lock pin is engaged with the second slot, the sliding lock pin is configured to be actuated to cause the sliding lock pin to move, relative to the second slot at the solar module frame and in a direction away from the lock pin, to a moved locking position at the second slot.

12. The system of claim 11, wherein, when the lock pin is engaged with the first slot and the sliding lock pin is engaged with the second slot, the sliding lock pin is configured to be actuated to cause the sliding lock pin to slide along at least each of the second slot at the solar module frame, the first channel, and the second channel in the direction away from the lock pin to the moved locking position.

13. The system of claim 12,
wherein the pin locking rail further comprises an intermediate channel between the first channel and the second channel,
wherein the lock pin extends across the first channel, the intermediate channel, and the second channel, and
wherein the sliding lock pin extends across the first channel, the intermediate channel, and the second channel.

14. The system of claim 13, wherein, when the sliding lock pin is actuated to cause the sliding lock pin to move, relative to the second slot at the solar module frame and in the direction away from the lock pin, the lock pin remains stationary relative to the first slot at the solar module frame.

15. The system of claim 13,
wherein the sliding lock pin comprises:
a sliding pin member, and
an adjustable fastener movably coupled to the sliding pin member, and
wherein the sliding lock pin is configured to be actuated to cause the sliding lock pin to slide along at least each of the second slot at the solar module frame, the first channel, and the second channel in the direction away from the lock pin to the moved locking position by rotating the adjustable fastener relative to the sliding pin member.

16. The system of claim 15, wherein the sliding lock pin further comprises:
a lock nut that is configured to move relative to the adjustable fastener in the direction away from the lock pin to cause the sliding lock pin to lock in place at the moved locking position at the second slot.

17. The system of claim 16, wherein the sliding lock pin further comprises:
a sliding lock pin housing that houses at least a portion of the adjustable fastener and at least a portion of a sliding pin member of the sliding lock pin therein, and wherein the lock nut is configured to move relative to the adjustable fastener in the direction away from the lock pin to cause the locking nut to engage the sliding lock pin housing to thereby constrain movement of the adjustable fastener to thereby lock the sliding lock pin in place at the moved locking position at the second slot.

18. The system of claim 11,
wherein the first slot defines a first cross-sectional geometry that comprises a vertical first slot inlet portion and a horizontal first slot portion extending from a first side of the vertical first slot inlet portion, and
wherein the second slot defines a second cross-sectional geometry that is different than the first cross-sectional geometry, the second cross-sectional geometry comprising a vertical second slot inlet portion, a first horizontal second slot portion extending from a first side of the of the vertical second slot inlet portion, and a second horizontal second slot portion extending from a second, opposite side of the vertical second slot inlet portion.

19. The system of claim 18, wherein the first slot further comprises a first slot endwall extending along a second side of the vertical first slot inlet portion opposite the first side of the vertical first slot inlet portion.

20. The system of claim 19, wherein the solar module has a first longitudinal side, and wherein the first slot and the second slot are defined at the first longitudinal side.
